(19) United States
(12) Patent Application Publication
(10) Pub. No.: US 2024/0249394 A1
(43) Pub. Date: Jul. 25, 2024

(54) METHOD FOR GENERATING TASK-SPECIFIC SCENE STRUCTURE

(71) Applicant: GIST(Gwangju Institute of Science and Technology), Gwangju (KR)

(72) Inventors: Hae Gon JEON, Gwangju (KR); Seung Hyun SHIN, Gwangju (KR); Ji Su SHIN, Gwangju (KR)

(73) Assignee: GIST(Gwangju Institute of Science and Technology), Gwangju (KR)

(21) Appl. No.: 18/410,525

(22) Filed: Jan. 11, 2024

(30) Foreign Application Priority Data
Jan. 20, 2023 (KR) 10-2023-0008665

(51) Int. Cl. G06T 5/60

(52) U.S. Cl. CPC G06T 5/60; G06T 2207/20084

(57) ABSTRACT

The present invention which is a method for generating a scene structure using a neural network model applied to a baseline network performing an image processing task by a plug-and-play scheme by using the scene structure includes: generating a plurality of eigenvectors for an image according to an affinity matrix of the image; and generating the scene structure by convolutioning the plurality of eigenvectors, and outputting the scene structure to the baseline network.

### CROSS-REFERENCE TO RELATED APPLICATIONS

This application claims the priority of Korean Patent Application No. 10-2023-0008665 filed on Jan. 20, 2023, in the Korean Intellectual Property Office, the disclosure of which is incorporated herein by reference.

### BACKGROUND OF THE INVENTION

### Field of the Invention

The present invention relates to a method for generating a scene structure which can be applied to various baseline networks performing an image processing task by a plug-and-play scheme.

### Description of the Related Art

In an image processing field using deep learning, a method of estimating a scene structure has been widely studied.

For example, the scene structure, specifically, a texture expression based on an edge of an object in an image has been studied to show high performance in a low-level vision task with the image as an input/output of a neural network, such as image denoising, deblurring, a super-resolution, inpainting, etc.

In addition, the scene structure is used to infer an object boundary in tasks such as joint filtering, depth upsampling, depth completion, etc. to quantify uncertainty, and improve initial prediction of a neural network model.

However, the scene structure so far is created to be applied individually to a neural network architecture that performs a specific task, and a loss function of the neural network for the generation of the scene structure is not defined separately. As a result, it takes a long time to train the neural network for generating the scene structure through end-to-end learning, and there is a limit that the neural network cannot be applied to other architectures after the training is completed.

### SUMMARY OF THE INVENTION

The present invention has been made in an effort to provide a neural network model which can be applied to various baseline networks performing an image processing task by a plug-and-play scheme

The objects of the present invention are not limited to the above-mentioned objects, and other objects and advantages of the present invention that are not mentioned can be understood by the following description, and will be more clearly understood by embodiments of the present invention. Further, it will be readily appreciated that the objects and advantages of the present invention can be realized by means and combinations shown in the claims.

In order to achieve the object, a method for generating a task-specific scene structure using a neural network model applied to a baseline network performing an image processing task by a plug-and-play scheme by using the scene structure according to an exemplary embodiment of the present invention includes: generating a plurality of eigenvectors for an image according to an affinity matrix of the image; and generating the scene structure by convolutioning the plurality of eigenvectors, and outputting the scene structure to the baseline network.

In an exemplary embodiment, the baseline network performs at least one task of denoising, image deblurring, image super-resolution, image inpainting, or depth upsampling, and depth completion.

In an exemplary embodiment, the generating of the eigenvector includes generating an eigenvector corresponding to a structure for each region of the image clustered according to the affinity matrix through an encoder/decoder in the neural network model.

In an exemplary embodiment, the generating of the eigenvector includes generating an eigenvector which makes a value of a quadratic form of the Laplacian matrix for the eigenvector become the minimum.

In an exemplary embodiment, the generating of the eigenvector includes generating an eigenvector which makes a loss function expressed by [Equation 1] below become the minimum.

$${ℒ}_{eigen} = {\sum }_{k} {Y}_{k}^{T} {LY}_{k} , \qquad [ Equation 1 ]$$

(Where Y represents the eigenvector, k represents a channel of the eigenvector, and L represents the Laplacian matrix)

In an exemplary embodiment, the generating of the eigenvector includes generating an eigenvector which makes linear combination of two loss functions expressed by [Equation 1] above and [Equation 2] below become the minimum.

$${ℒ}_{spacial} = {\sum }_{k} ( {\vert {Y}_{k} \vert}^{v} + {\vert 1 - {Y}_{k} \vert}^{v} ) - 1 , \qquad [ Equation 2 ]$$

(Where γ is a hyperparameter)

In an exemplary embodiment, the generating of the scene structure includes generating the scene structure by inputting the plurality of eigenvectors into a single convolution layer.

In an exemplary embodiment, the single convolution layer convolutions the plurality of eigenvectors based on a weight learned according to a task of the baseline network.

The present invention is applied to various baseline networks performing an image processing task by a plug-and-play scheme to significantly enhance the performance of a baseline network regardless of what the task is.

In addition to the above-described effects, the specific effects of the present invention are described together while describing specific matters for implementing the invention below.

### BRIEF DESCRIPTION OF THE DRAWINGS

The patent or application file contains at least one drawing executed in color. Copies of this patent or patent application publication with color drawing (s) will be provided by the office upon request and payment of the necessary fee.

FIG. 1 is a diagram a state in which a scene structure is used in a joint depth upsampling task.

FIG. 2 is a diagram a state in which the scene structure is used in an image dinoising task.

FIG. 3 is a diagram schematically illustrating an operation of a neural network model applied to the present invention.

FIG. 4 is a diagram illustrating a structure according to one example of the neural network model illustrated in FIG. 3.

FIG. 5 is a diagram illustrating an eigenvector according to a coefficient used for linear combination of a loss function.

FIG. 6 is a diagram illustrating a state in which the neural network model of the present invention is applied to a baseline network performing a depth upsampling task by a plug-and-play scheme.

FIG. 7 is a diagram illustrating a state in which the neural network model of the present invention is applied to a baseline network performing an image denoising task by the plug-and-play scheme.

FIG. 8 is a diagram illustrating a comparison between a result (a depth map and an error map) of applying the present invention to the depth upsampling task and results of other models.

FIG. 9 is a diagram illustrating a comparison between a performance derived by applying the present invention to the depth upsampling task and performances of other models.

FIG. 10 is a diagram illustrating a comparison between a result of applying the present invention to the image denoising task and results of other models.

FIG. 11 is a diagram illustrating a comparison between a performance derived by applying the present invention to the image denoising task and performances of other models.

### DETAILED DESCRIPTION OF THE PREFERRED EMBODIMENT

The above-mentioned objects, features, and advantages will be described in detail with reference to the drawings, and as a result, those skilled in the art to which the present invention pertains may easily practice a technical idea of the present invention. In describing the present invention, a detailed description of related known technologies will be omitted if it is determined that they unnecessarily make the gist of the present invention unclear. Hereinafter, a preferable embodiment of the present invention will be described in detail with reference to the accompanying drawings. In the drawings, the same reference numeral is used for representing the same or similar components.

Although the terms “first”, “second”, and the like are used for describing various components in this specification, these components are not confined by these terms. The terms are used for distinguishing only one component from another component, and unless there is a particularly opposite statement, a first component may be a second component, of course.

Further, in this specification, any component is placed on the “top (or bottom)” of the component or the “top (or bottom)” of the component may mean that not only that any configuration is placed in contact with the top surface (or bottom) of the component, but also that another component may be interposed between the component and any component disposed on (or under) the component.

In addition, when it is disclosed that any component is “connected”, “coupled”, or “linked” to other components in this specification, it should be understood that the components may be directly connected or linked to each other, but another component may be “interposed” between the respective components, or the respective components may be “connected”, “coupled”, or “linked” through another component.

Further, a singular form used in the present invention may include a plural form if there is no clearly opposite meaning in the context. In the present invention, a term such as “comprising” or “including” should not be interpreted as necessarily including all various components or various steps disclosed in the present invention, and it should be interpreted that some component or some steps among them may not be included or additional components or steps may be further included.

In addition, in this specification, when the component is called “A and/or B”, the component means, A, B or A and B unless there is a particular opposite statement, and when the component is called “C or D”, this means that the term is C or more and D or less unless there is a particular opposite statement.

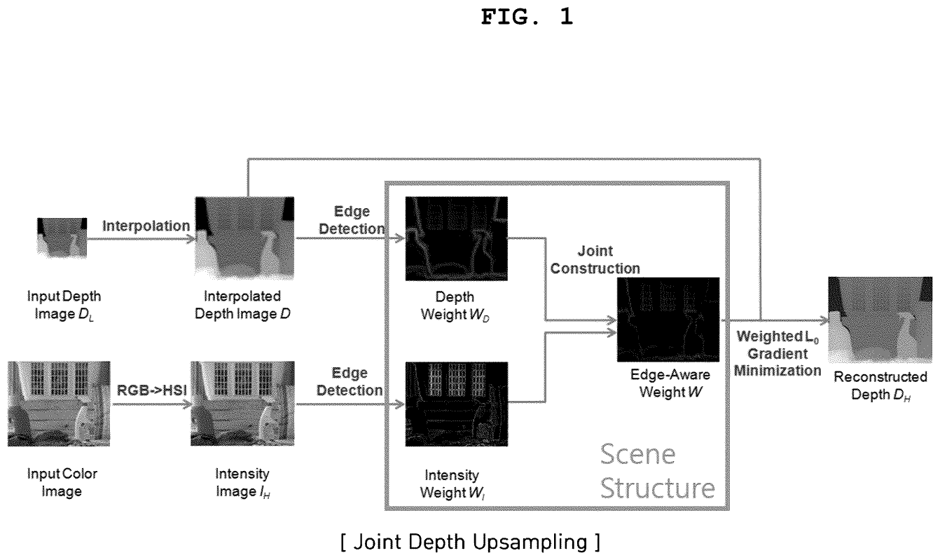

The present invention relates to a method for generating a scene structure which can be applied to various baseline networks performing an image processing task by a plug-and-play scheme. Hereinafter, referring to FIGS. 1 to 11, a method for generating a task-specific scene structure according to an exemplary embodiment of the present invention will be described in detail.

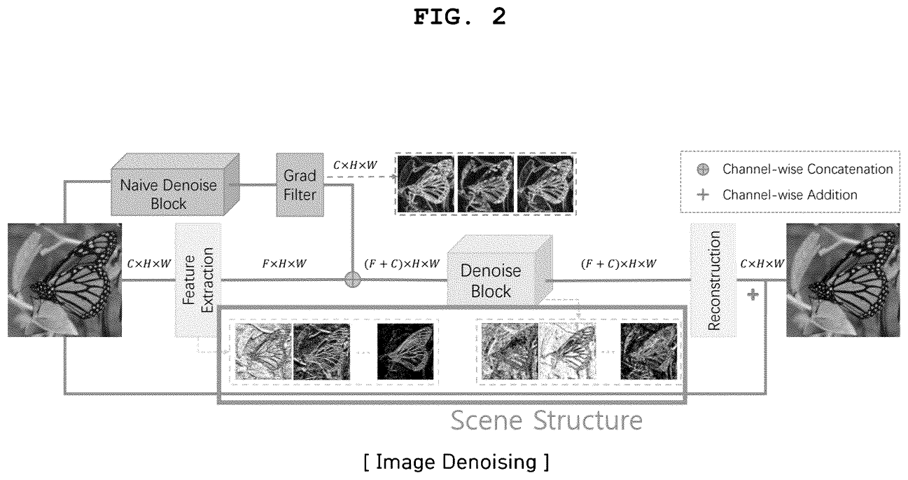

FIG. 1 is a diagram a state in which a scene structure is used in a joint depth upsampling task and FIG. 2 is a diagram a state in which the scene structure is used in an image dinoising task.

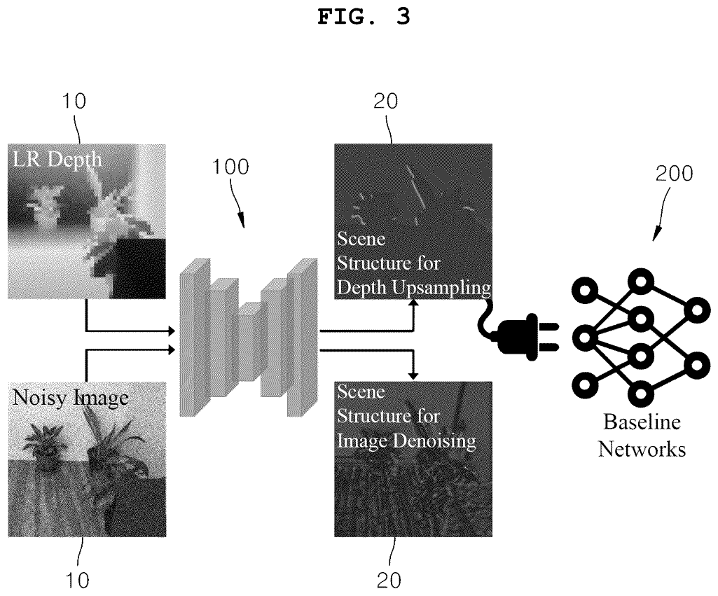

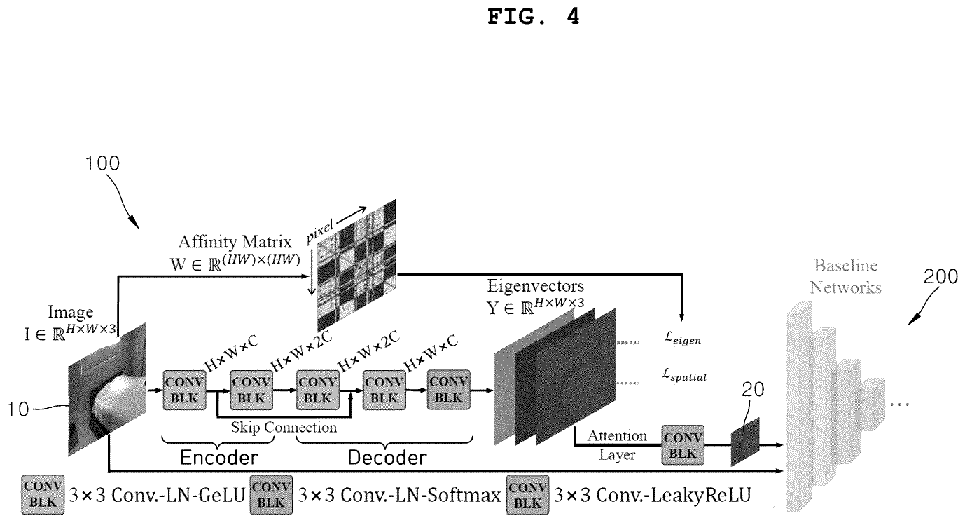

FIG. 3 is a diagram schematically illustrating an operation of a neural network model applied to the present invention, and FIG. 4 is a diagram illustrating a structure according to one example of the neural network model illustrated in FIG. 3.

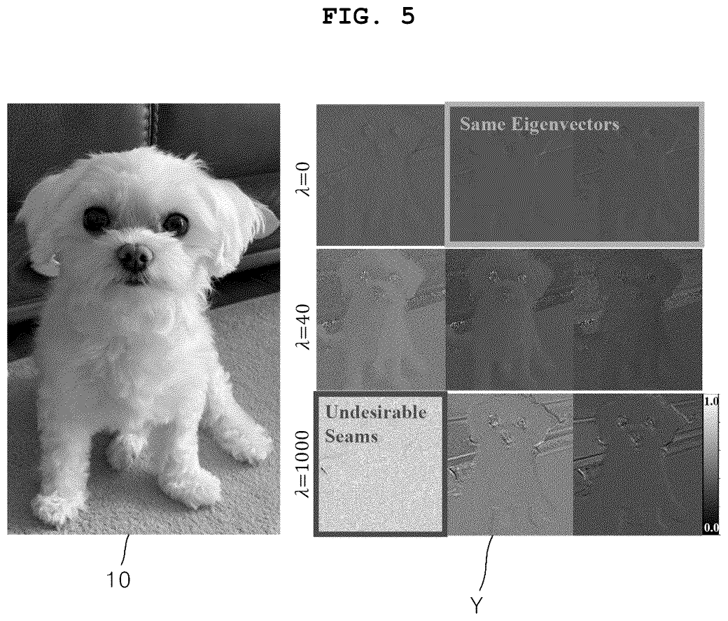

FIG. 5 is a diagram illustrating an eigenvector according to a coefficient used for linear combination of a loss function.

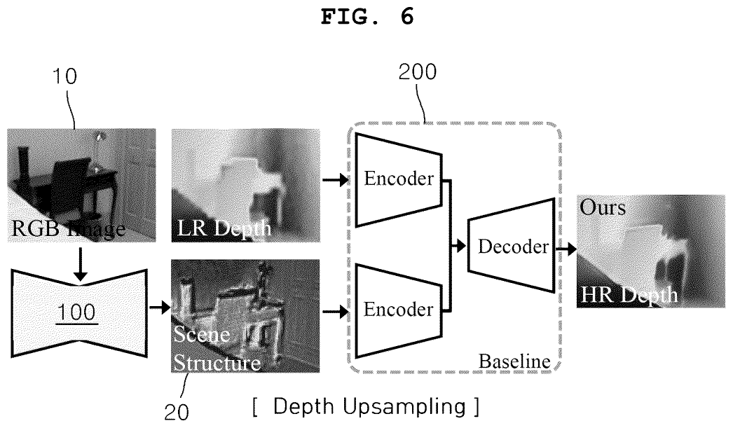

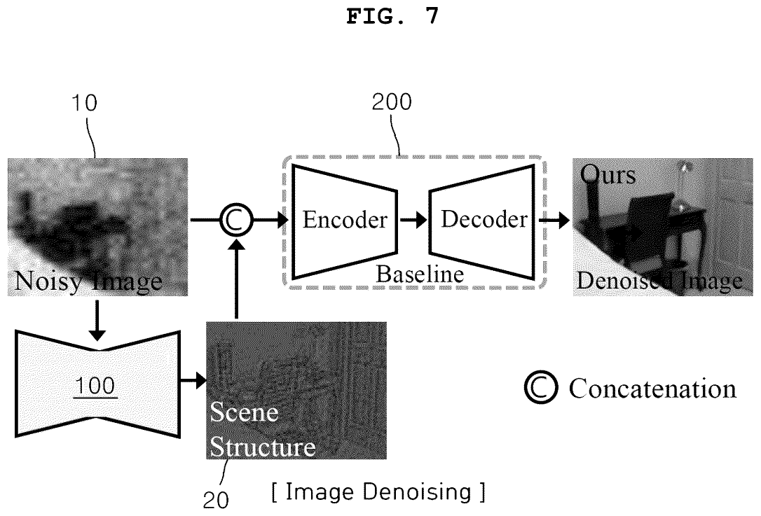

FIG. 6 is a diagram illustrating a state in which the neural network model of the present invention is applied to a baseline network performing a depth upsampling task by a plug-and-play scheme. Further, FIG. 7 is a diagram illustrating a state in which the neural network model of the present invention is applied to a baseline network performing an image denoising task by the plug-and-play scheme.

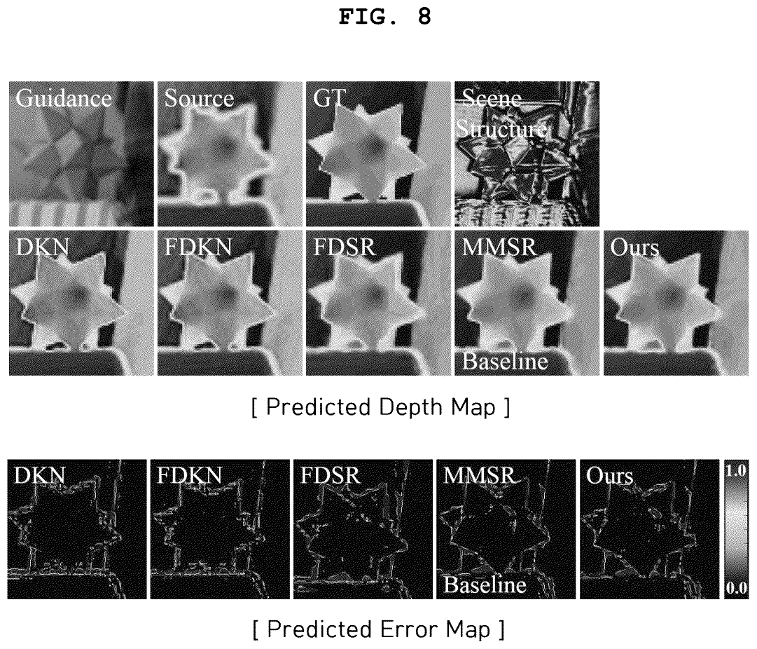

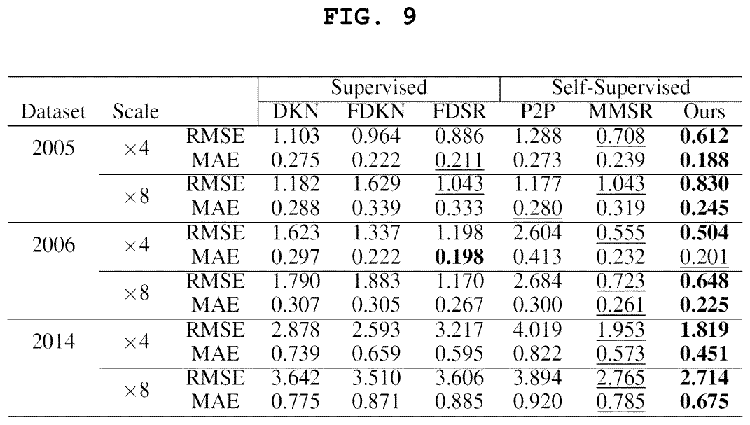

FIG. 8 is a diagram illustrating a comparison between a result (a depth map and an error map) of applying the present invention to the depth upsampling task and results of other models, and FIG. 9 is a diagram illustrating a comparison between a performance derived by applying the present invention to the depth upsampling task and performances of other models.

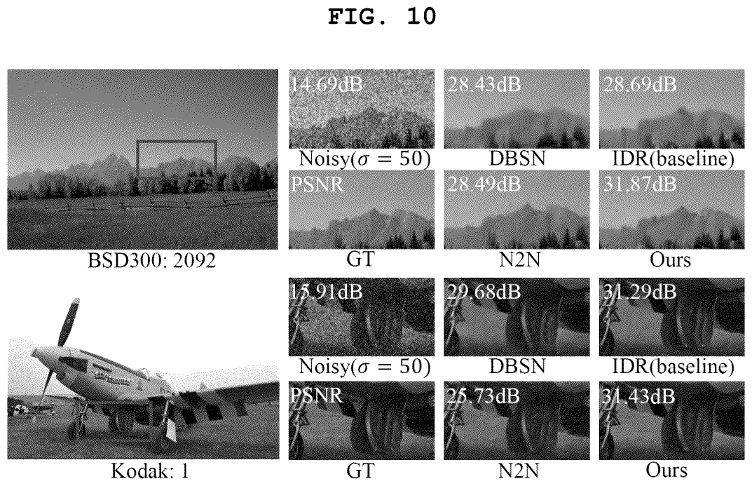

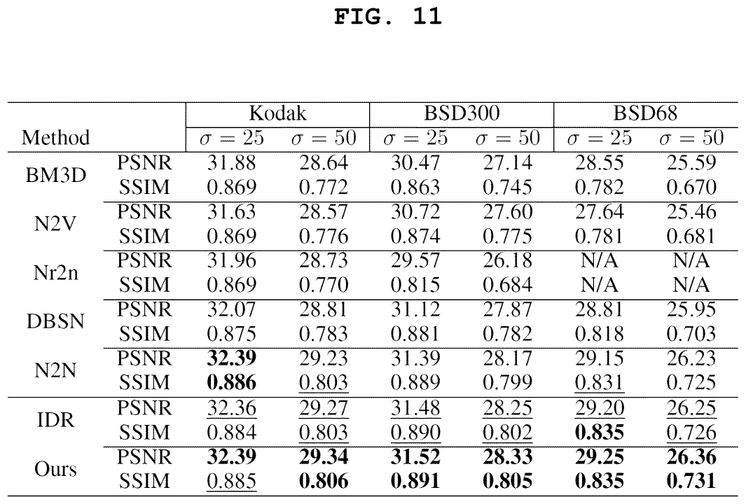

FIG. 10 is a diagram illustrating a comparison between a result of applying the present invention to the image denoising task and results of other models, and FIG. 11 is a diagram illustrating a comparison between a performance derived by applying the present invention to the image denoising task and performances of other models.

First, the scene structure is described with reference to FIGS. 1 and 2.

In joint depth upsampling illustrated in FIG. 1, as a task that predicts a high-resolution depth map D_{H} when a low-resolution depth map D_{L} is given, a high-resolution depth map D_{H} is predicted by considering a weight W_{D} for a depth itself and a weight W_{I} for an intensity of a high-resolution RGB image.

Here, the weight W_{D} for the depth, the weight for the intensity of the RGB image, and a joint weight W thereof may all serve as a structure guidance representing a boundary of an object in a depth upsampling operation, and the scene structure may be a concept including the structure guidance.

Further, in the image denoising illustrated in FIG. 2 as a task which predicts a denoised clean image when a noisy image is given, the structure guidance is generated based on a feature of the image, and the image is encoded and decoded based on the structure guidance to predict a high-resolution image. Here, the structure guidance may represent a texture of the image, and the scene structure may be a concept including such a structure guidance.

In addition to the examples illustrated in FIGS. 1 and 2, the scene structure described in the present invention may include arbitrary features representing the texture of the image, the boundary of the object in the image, a structure, a shape, etc., and may include all concepts expressed as the structure guidance, a structural guidance, a scene structure guidance, a structure feature, a structural feature, etc., in the technique field.

Referring to FIG. 3, in the present invention, the scene structure 20 may be generated by using the neural network model 100 applied to a baseline network 200 performing an image processing task by using the above-described scene structure 20 by the plug-and-play scheme, and in the present invention, a scene structure 20 suitable for the task of the baseline network 200 may be generated through such a scheme.

Here, the baseline network 200 may include a network that performs at least one task of denoising, image deblurring, image super-resolution, image inpainting, or depth upsampling, and depth completion.

The method for generating the task-specific scene structure of the present invention may be performed by a processor, and the processor may be implement as a computing device such as a central processing unit (CPU), a graphics processing unit (GPU), etc., and may additionally include at least one physical element of respective steps illustrated in FIG. 1 may be performed by a processor implemented as a central processing unit (CPU), a graphics processing unit (GPU), etc., and the processor may further include at least one physical element among application specific integrated circuits (ASICs), digital signal processors (DSPs), digital signal processing devices (DSPDs), programmable logic devices (PLDs), field programmable gate arrays (FPGAs), a controller, and micro-controllers.

Hereinafter, an operation of the processor will be described in detail.

Referring to FIG. 4, the processor may generate a plurality of eigenvectors Y for an image 10 according to an affinity matrix W of the image. Specifically, the processor may input the image 10 provided from an external server or a user terminal into the neural network model 100, and generate the plurality of eigenvectors Y for the image through the neural network model 100.

The neural network model 100 may be an encoder and a decoder. The encoder may include two pairs of convolution layers (specifically, convolution layers having a filter (or kernel) size of 3×3) connected to layer normalization (LN) and a GeLU activation function.

The decoder may include three pairs of convolution layers (specifically, convolution layers having a filter (or kernel) size of 3×3) connected to the layer normalization (LN) and the GeLU activation function, and may further include a softmax layer at the end thereof.

The encoder may extract a feature by encoding the image 10 through the above-described layer, and the decoder may generate the eigenvector Y by decoding the feature through the above-described layer. In this case, the neural network model 100 may generate the eigenvector Y by referring to the affinity matrix W of the image 10, and the affinity matrix W may be determined by the processor.

The processor may determine an inter-pixel affinity. Specifically, the processor sets each pixel of the image 10 as a node, and sets a connection between adjacent pixels as an edge to structuralize each pixel as graph data, and calculate an affinity between respective graph data. In this case, various schemes used in the technical field may be applied to an affinity calculation scheme.

The calculated inter-pixel affinity may be expressed as the affinity matrix W, and the affinity matrix W may be constituted by, for example, an affinity value which a pixel corresponding to a height of the image 10 has with respect to a pixel corresponding to a width of the image 10.

The encoder-decoder may receive the image 10 by the processor, and output the eigenvector Y according to the affinity matrix W. Specifically, the encoder-decoder may generate the eigenvector Y corresponding to a structure for each region of an image 10 clustered according to the affinity matrix W.

The image 10 may be clustered into a plurality of regions according to the affinity. The encoder may extract the feature in the image 10 by encoding the image 10 for each region, and the decoder may generate the eigenvector Y for each region by decoding the extracted feature.

The eigenvector Y may be generated as a number (channel number) corresponding to each region, and may be generated as, for example, 3 in the present invention. Meanwhile, the data in the eigenvector Y may be constituted by an eigen value R^{H×W×3} of the image 10 divided into each region.

Meanwhile, since a ground truth (GT) for the eigenvector Y is not present, supervised learning for the encoder-decoder may be impossible. As a result, the processor may set a loss function so as for the encoder-decoder to generate the eigenvector Y for each region having a mutual affinity according to the affinity matrix W, and the encoder-decoder is unsupervised learned so that the loss function becomes minimum to output the eigenvector Y for each region.

In one example, the processor may derive a Laplacian matrix L by transforming the affinity matrix W, and generate the eigenvector Y which makes a value of a quadratic form of the Laplacian matrix L for the eigenvector Y become the minimum through the encoder-decoder.

As described above, since the affinity matrix W is calculated based on graph data defined by the node and the edge, the processor may use the Laplacian matrix L in order to cluster respective nodes in a graph. The Laplacian matrix L for the affinity matrix W may be defined as in [Equation 1] below, and the processor may derive the Laplacian matrix L by substituting the affinity matrix W into [Equation 1].

$$L = D - W \qquad [ Equation 1 ]$$

Where D as a degree matrix may be a diagonal matrix including the number of edges connected to one node as a value.

Subsequently, the processor may derive a secondary format L_{q} of the Laplacian matrix for the eigenvector Y according to [Equation 2] below, and generate the eigenvector Y which makes the secondary format L_{q} becomes the minimum through the encoder-decoder. In other words, the processor may set the secondary format L_{q} of the Laplacian matrix for the eigenvector Y as the loss function of the encoder-decoder.

$${L}_{q} = {Y}^{T} LY \qquad [ Equation 2 ]$$

Meanwhile, a plurality of (a plurality of channels of) eigenvectors Y are generated as described above, and the encode-decoder may preferably generate an eigenvector Y which makes a sum of loss functions determined by the plurality of eigenvectors Y become the minimum.

As a result, the processor may set [Equation 3] below as a first loss function of the encoder-decoder.

$${ℒ}_{eigen} = {\sum }_{k} {Y}_{k}^{T} {LY}_{k} , \qquad [ Equation 3 ]$$

(Where k represents the channel of the eigenvector Y)

According to the first loss function, the encoder-decoder may output the eigenvector Y which makes the secondary format L_{q} of the Laplacian matrix for the affinity matrix W become the minimum, and the output eigenvector Y may include a structural feature for each region of the image 10.

However, when only the first loss function L_{eigen} is applied, values of all pixel indexes of the eigenvector Y output from the encoder-decoder may converge to 0 or a problem in that the eigenvectors Y of respective regions are the same may occur, so the processor may further apply an additional loss function to the encoder-decoder.

Specifically, the processor may further generate a second loss function Lₛₚₐₜᵢₐₗ expressed as in [Equation 4] below.

$${ℒ}_{spatial} = {\sum }_{k} ( {\vert {Y}_{k} \vert}^{v} + {\vert 1 - {Y}_{k} \vert}^{v} ) - 1 \qquad [ Equation 4 ]$$

Where γ may be a hyperparameter, and the processor, evaluates the performance of the neural network model 100 for each γ to set γ to an appropriate value, and in the present invention, γ may be set to, for example, 0.9.

Finally, the processor may set a final loss function L_{ssg} represented by [Equation 5] below through linear combination of the first and second loss functions (L_{eigen} and Lₛₚₐₜᵢₐₗ). Accordingly, sparsity and diversity of the eigenvector Y may increase, and as a result, the distinction between the structural feature of the image 10 contained by the eigenvector Y for each channel may be strengthened.

The encoder-decoder may be unsupervised learned to generate the eigenvector Y which makes the final loss function L_{ssg} become the minimum.

$${ℒ}_{ssg} = {ℒ}_{eigen} + {λℒ}_{spatial} \qquad [ Equation 5 ]$$

Where λ may also be the hyperparameter, and the processor evaluates the performance of the neural network model for each λ to set λ to an appropriate value.

Referring to FIG. 5, when λ is 0, the encoder-decoder outputs the eigenvector Y by considering only the first loss function L_{eigen}, and there may be the problem in that the eigenvectors Y of two channels among the eigenvectors Y of three channels are equally output as described above.

Further, when λ is set to be excessively large like 1000, the encoder-decoder may output the eigenvector Y by overwhelmingly considering only the second loss function Lₛₚₐₜᵢₐₗ, and the second loss function Lₛₚₐₜᵢₐₗ may cause a seams not appropriate to the eigenvector Y.

In the present invention, the processor may set the λ value to, for example, 40 through performance evaluation of the neural network model 100 according to λ.

The unsupervised learning may be performed before the neural network model 100 plugs in a baseline network 200, and after the unsupervised learning is completed the neural network model may plug in the baseline network 200,

After the plug-in, the processor may generate structure 20 by convolutioning the plurality of eigenvectors Y generated according to the above-described method, and output the scene structure to the baseline network 200.

Referring back to FIG. 4, the neural network model 100 of the present invention may further include a single convolution layer connected to a LeakyReLU activation function and having a filter (or kernel) size of 3×3 at an end connected to the baseline network 200.

The processor may input the plurality of eigenvectors Y into the single convolution layer, and the single convolution layer convolutions the plurality of eigenvectors Y to generate the scene structure 20. That is, the single convolution layer receives the plurality of eigenvectors Y to output the scene structure 20.

In this case, the processor may convolution the plurality of eigenvectors Y according to a weight determined by a task of the baseline network 200. Specifically, a filter of the single convolution layer may have the weight, and when the neural network model 100 plugs in the baseline network 200, the weight of the filter may be learned according to the task of the baseline network 200.

Consequently, the single convolution layer may convolution the plurality of eigenvectors Y based on the weight learned and updated according to the task of the baseline network 200, and output the scene structure 20 generated through the convolution to the baseline network 200.

As a result, the scene structure 20 output to the baseline network 200 may be optimized to the task of the baseline network 200.

By taking FIG. 6 as an example, when the neural network model 100 of the present invention plugs in the baseline network 200 performing the depth upsampling task, the neural network model 100 may receive the image 10, and output the scene structure 20 representing the seams of the object in the image 10, i.e., the structure guidance.

Further, by taking FIG. 7 as an example, when the neural network model 100 of the present invention plugs in the baseline network 200 performing the image denoising task, the neural network model 100 may receive the image 10, and output the scene structure 20 representing the texture of the image 10, i.e., the structure guidance.

As a result, a dramatic performance enhancement may be achieved through application of the present invention without an internal architecture for autonomously generating the structure guidance. That is, the present invention is applied to various baseline networks 200 performing the image processing task by the plug-and-play scheme to significantly enhance the performance of the baseline network 200 regardless of what the task is.

Referring to FIG. 8 illustrating a comparison between the output for the depth upsampling task and those in the related art, it can be seen that when the present invention is applied to a baseline network of Mutual Modulation Image Super-Resolution (MMSR) (Ours), a predicted depth map is generated, which is most similar to an actual measurement value, and a predicted error map having a smallest error value is generated.

Referring to FIG. 9, it can be seen that when the present invention (ours) is quantitatively compared with the related art with respect to the depth upsampling task, the present invention shows overwhelming or very high performance in terms of Root Mean Square Error (RMSE) as compared with deformable kernel network (DKN), fast deformable kernel network (FDKN), fast depth map super-resolution (FDSR), bidirectional point displacement net (P2P), and MMSR.

Further, referring to FIG. 10 illustrating a comparison between the output of the image denoising task and those in the related art, it can be seen that when the present invention is applied to a baseline network of self-supervised image denoising via Iterative Data Refinement (IDR) (ours), a denoising image is generated, which is most similar to the actual measurement value.

Referring to FIG. 11, it can be seen that when the present invention (ours) is quantitatively compared with the related art in terms of the image denoising task, the present invention shows overwhelming or very high performance in terms of Peak Signal-to-Noise Ratio (PSNR) and Structural Similarity Index Measure (SSIM) as compared with Block-Matching and 3D filtering (BM3D), Noise2Void (N2V), noiser2noise (Nr2n), Dilated Blind Spot Network (DBSN), Noise2Noise (N2N), and IDR.

Although the present invention has been described above by the drawings, but the present invention is not limited by the exemplary embodiments and drawings disclosed in the present invention, and various modifications can be made from the above description by those skilled in the art within the technical ideas of the present invention. Moreover, even though an action effect according to a configuration of the present invention is explicitly disclosed and described while describing the exemplary embodiments of the present invention described above, it is natural that an effect predictable by the corresponding configuration should also be conceded.

What is claimed is:

1. A method for generating a task-specific scene structure using a neural network model applied to a baseline network performing an image processing task by a plug-and-play scheme by using the scene structure, the method comprising:
generating, by a processor, a plurality of eigenvectors for an image according to an affinity matrix of the image; and
generating, by the processor, the scene structure by convolutioning the plurality of eigenvectors, and outputting the scene structure to the baseline network.

2. The method of claim 1, wherein the baseline network performs at least one task of denoising, image deblurring, image super-resolution, image inpainting, or depth upsampling, and depth completion.

3. The method of claim 1, wherein the generating of the includes generating an eigenvector eigenvector corresponding to a structure for each region of the image clustered according to the affinity matrix through an encoder/decoder in the neural network model.

4. The method of claim 1, wherein the generating of the eigenvector includes
transforming the affinity matrix, and deriving a Laplacian matrix, and
generating an eigenvector which makes a value of a quadratic form of the Laplacian matrix for the eigenvector become the minimum.

5. The method of claim 4, wherein the generating of the eigenvector includes generating an eigenvector which makes a loss function expressed by [Equation 1] below become the minimum.
$${ℒ}_{eigen} = {\sum }_{k} {Y}_{k}^{T} {LY}_{k} , \qquad [ Equation 1 ]$$
(Where Y represents the eigenvector, k represents a channel of the eigenvector, and L represents the Laplacian matrix)

6. The method of claim 5, wherein the generating of the eigenvector includes generating an eigenvector which makes linear combination of two loss functions expressed by [Equation 1] above and [Equation 2] below become the minimum.
$${ℒ}_{spatial} = {\sum }_{k} ( {\vert {Y}_{k} \vert}^{v} + {\vert 1 - {Y}_{k} \vert}^{v} ) - 1 , \qquad [ Equation 2 ]$$
(Where γ is a hyperparameter)

7. The method of claim 1, wherein the generating of the scene structure includes generating the scene structure by inputting the plurality of eigenvectors into a single convolution layer.

8. The method of claim 7, wherein the single convolution layer convolutions the plurality of eigenvectors based on a weight learned according to a task of the baseline network.
